(19) United States
(12) Patent Application Publication
(10) Pub. No.: US 2025/0319721 A1
(43) Pub. Date: Oct. 16, 2025

(54) ELECTRIC WHEEL

(71) Applicant: JOEY CHIH-WEI HUANG, Changhua (TW)

(72) Inventor: JOEY CHIH-WEI HUANG, Changhua (TW)

(21) Appl. No.: 19/095,471

(22) Filed: Mar. 31, 2025

(30) Foreign Application Priority Data
Apr. 16, 2024 (CN) 202410454660.0

(51) Int. Cl. B60B 27/00; B60K 7/00; B60K 17/04; H02K 5/10; H02K 5/20; H02K 7/116; H02K 11/00

(52) U.S. Cl. CPC B60B 27/0031; H02K 5/10; H02K 5/207; H02K 7/116; H02K 11/0094; B60B 2900/211; B60B 2900/5112; B60K 7/0007; B60K 2007/0092; B60K 17/043; H02K 2205/09; H02K 2211/03

(57) ABSTRACT

The invention relates to an electric wheel hub comprising a driving wheel shell, a driven wheel shell connected to the driving wheel shell, a hub axle penetrating the driving wheel shell and the driven wheel shell, a housing space formed by the inner walls of the driving wheel shell and the driven wheel shell, a drive component arranged in the housing space, and a heat dissipation mechanism for dissipating heat from the housing space, the drive component comprising a drive motor arranged on one side of the hub axle and a transmission component arranged in the housing space, the drive motor driving the driving wheel shell to rotate about the hub axle via the transmission component. The present invention realizes the electric rotation of the wheel hub by driving the wheel hub on the wheel hub axle through the transmission component by the internal driving motor.

### TECHNICAL FIELD

The present invention relates to the technical field of electric motors and refers in particular to an electric wheel hub.

### DISCUSSION OF RELATED ART

A variety of different electric hub motors have been discussed in United States patents. For example, in U.S. Pat. No. 6,974,399 entitled, “Hub Motor Mechanism,” by Chiu-Hsiang Lo, published Dec. 13, 2005, the inventor describes, “An electrically driven hub includes an electrical mechanism, including an electrical motor and planetary gear system connected to the electrical mechanism. A first fixed shaft is connected to the stator of the electrical motor and a second fixed shaft is connected to a second end of the stator of the electrical motor. The first and second fixed shafts are connected to the vehicle frame. A one-way clutch is connected between a cover of the hub and the planetary gear system so that the hub is rotated when the planetary gear system is activated by the motor.”

For example, in U.S. Pat. No. 7,249,643 entitled, “Hub Motor,” by Yoel Etzioni, Philip Solomon, and Michael Glazman, published Jul. 31, 2007, the inventors describe, “The invention provides a motor for a wheeled conveyance having a stationary electric motor encased in a rotating, multi-part housing, at least one of the parts of the housing constituting a wheel disk and a wheel rim, and a reduction gear internal or external to the motor, the output member of which is adapted to drive at least one part of the multi-part housing, wherein the rim portion of the multi-part housing carries, and is in direct contact with, a wheel tire.”

For example, in U.S. Pat. No. 8,245,804, entitled, “Electrical Bicycle Hub,” by Jacobus Hubertus Maria van Rooij, published Aug. 21, 2012, the inventor describes, “Electrical motorized bicycle hub with a stationary wheel shaft which rotatingly supports a hub housing, in which is provided a rotor which can rotate around the wheel shaft and which comprises-a first part, parallel to the wheel shaft and carrying a ring or permanent magnets which cooperate with a ring of stator windings, supported by a carrier, and a second part rotatingly supported by the wheel shaft and connected to the first part by means of a transition part, and with furthermore a wheel transmission, driven by the second rotor part and which reduces the rotation speed thereof, the output thereof driving the hub housing, this wheel transmission being accommodated in the space between the stator windings and the wheel shaft. Preferably, the first rotor part is rotatingly supported on one of the hub walls opposite thereto while seals are provided between the cylindrical winding carrier and the parts opposite thereto.”

For example, in U.S. Pat. No. 10,432,064, entitled, “Hub Motor Arrangement or vehicle with Hub Motor Arrangement,” by Joey Chih-wei Huang, published Oct. 1, 2019, the inventor describes, “A ride-on vehicle, such as for a child, includes a vehicle body and one or more wheels that support the vehicle body relative to a surface. At least one of the wheels includes a hub motor arrangement that provides a drive torque for propelling the vehicle. The hub motor arrangement includes housing defining an interior space. An axle or other mounting element(s) define an axis of rotation of the housing. Preferably, the axle or other mounting element(s) do not pass completely through the housing. A motor drives the housing through a transmission. Preferably, the motor is a standard, compact motor that is positioned on the axis of rotation and can be laterally offset from a central plane of the housing. In some embodiments, a traction element is carried directly by the housing.”

For example, in United states publication number 2008/0179120, entitled, “Motorized Electric Wheel,” by Stanley F. Stafford, published Jul. 31, 2008, the inventor describes, “A motorized electric wheel for a vehicle including a circular armature having a central hole and comprising a coil wheel having electro-magnetic coils; a shaft inserted through the hole and being fixed to the circular armature and to the vehicle so that the shaft does not rotate; a pair of bearings fixed to the shaft, one bearing on each side of the armature; a cover rotatably surrounding the armature and resting on the bearings; and two wires connected to a Switching mechanism, each of the wires connected to the electro-magnetic coils. The motorized electric wheel of the invention may be used for any type of motorized vehicle.”

### SUMMARY OF THE INVENTION

In order to solve the above technical problems, it is an object of the present invention to provide a motorized wheel hub in which the motor is built into the hub, the wheel hub shaft axle is able to run through both sides of the hub and is able to have heat dissipation function. To achieve the above objective, the present invention adopts the following technical solution:

A motorized wheel hub has an active wheel housing, driven wheel housing connected to the active wheel housing, a wheel hub shaft axle running through the active wheel housing and the driven wheel housing, an accommodating containment cavity surrounded by the inner walls of the active wheel housing and the driven wheel housing, a drive assembly disposed within the accommodating containment cavity, and a heat dissipation mechanism for dissipating heat from the accommodating containment cavity, the drive assembly comprising a drive motor disposed on one side of the hub axle and a transmission assembly disposed within the accommodating containment cavity, the driving motor driving the drive assembly through the transmission assembly to rotate the active wheel housing around the wheel hub shaft axle. The drive assembly comprises a driving motor disposed on one side of the wheel hub shaft axle and a transmission assembly disposed in the accommodating containment cavity, the drive motor driving the active wheel housing to rotate around the wheel hub shaft axle through the transmission assembly.

Further, the heat dissipation structure comprises an exhaust hole air vent and an air intake hole provided on the active wheel housing and/or the driven wheel housing, the exhaust hole air vent and air intake hole both being connected to the holding accommodation space.

Further, the exhaust hole air vent and air inlet hole are provided on the side wall of the driven wheel housing, the exhaust hole is provided with an air guide block on one side of the exhaust hole, one side of the air guide block is connected to the side wall of the exhaust hole, and the other side of the air guide block extends to an angled setting within the holding accommodation space.

Further, the distance between the center of the exhaust hole and the center of the wheel hub shaft axle is greater than the distance between the center of the intake hole and the center of the wheel hub shaft axle.

Further, the transmission assembly comprises a toothed gear ring coupled to the active wheel housing, a first transmission drive gear set on an output shaft of a driving motor, a gear shaft set in an holding accommodation space, a second transmission drive gear set on the gear shaft, and a third transmission drive gear set on the gear shaft, the first transmission drive gear engaging with the second transmission drive gear, and the third transmission drive gear engaging with the toothed gear ring.

Still further, the electric hub further comprises a dust-proof space for dustproofing the transmission assembly; the dust-proof space comprising a first dust cover and a second dust cover provided in the holding accommodation space, the first dust cover being used to cover the output shaft of the driving motor, the first transmission drive gear, the second transmission drive gear, the third transmission drive gear, and the upper portion of the toothed gear rim, the second dust cover being used to cover the output shaft of the driving motor, the first transmission gear, the second transmission gear, the third transmission drive gear, and the upper portion of the toothed gear ring, the second dust cover are used to cover the lower part of the toothed gear ring.

Further, the first dust cover, the second dust cover and the active wheel housing are surrounded to form a dust-proof space, the driving motor is located outside of the dust-proof space, and the output end of the driving motor and the transmission assembly are located inside the dust-proof space; and the side edges of the first dust cover and the side edges of the second dust cover are provided with seals between them and the inner wall of the active wheel housing.

Further, the motorized hub further comprises a stationary seat provided in the holding accommodation space connected to the hub shaft, the stationary seat being provided with a bushing that fits with the hub shaft, the fixed seat being provided with a motor mounting cavity for mounting and fixing of the driving motor, the fixed seat being provided with a hole for mounting and fixing of the gear shaft; the motor mounting cavity being provided with a ventilation hole at the top; the first dust cover being connected to the top of the fixed seat. The first dust cover is connected to the top of the fixed seat, the first dust cover is provided with a gear housing cavity for accommodating the first transmission drive gear, second transmission drive gear, third transmission drive gear and gear shaft; the second dust cover is connected to the fixed seat and is located below the first dust cover.

Further, the electric wheel hub further comprises a light emitting assembly, the light emitting assembly comprising a light emitting member, a circuit board, a coil, and a toroidal magnetic core, the circuit board and coil being annular in shape; the toroidal magnetic core being fixedly mounted to the wheel hub shaft axle, the circuit board and coil being disposed on the active wheel housing, the toroidal magnetic core being located in the inner portion of the circuit board, and the coil being disposed in the inner portion of the circuit board located between the circuit board and the toroidal magnetic core; the light emitting member is provided on the active wheel housing electrically connected to the circuit board.

Beneficial effect of the present invention: the wheel hub shaft axle of the present invention runs through both sides of the active wheel housing and the driven wheel housing, the drive motor is provided on one side of the wheel hub shaft axle, and the output shaft of the drive motor drives the active wheel housing and the driven wheel housing to rotate around the hub shaft through the transmission assembly, thus realizing the function of the motorized wheel hub. The difference between the design of the present structure and the conventional hub motor structure is that the wheel hub shaft axle is able to run through both sides of the hub, and the wheel hub shaft axle serves as a fixed shaft connected to the outside and is not a drive shaft. The design of this structure can, on the one hand, solve the defect that the existing hub motor can only be connected to the outside on one side; on the other hand, the wheel hub shaft axle's penetration design can effectively make the assembly of the wheel hub and the external parts more stable and reliable, and also ensure the coaxially between the wheel hub and the wheel hub shaft axle, so as to improve the balance and stability of the wheel hub's rotation. At the same time, the electric wheel hub also has a heat dissipation mechanism that can discharge the heat inside the wheel hub, so that the temperature inside the wheel hub will not be too high, thus improving the stability of the use of the electric wheel hub.

### BRIEF DESCRIPTION OF THE DRAWINGS

FIG. 1 shows a schematic diagram of the three-dimensional structure of the present invention.

FIG. 2 shows a schematic diagram of the decomposed structure of the present invention.

FIG. 3 shows a full sectional view of the present invention.

FIG. 4 shows a front view of the driven wheel housing of the present invention.

FIG. 5 shows a sectional view along the direction A-A in FIG. 4.

FIG. 6 shows a schematic diagram of the structure of the present invention after hiding the follower wheel housing.

FIG. 7 shows a schematic diagram of the structure of the drive assembly of the present invention.

FIG. 8 shows a schematic diagram of the structure of the present invention after hiding the active wheel housing.

FIG. 9 shows a schematic diagram of the structure of the fixed seat of the present invention.

FIG. 10 shows a schematic diagram of the structure of the second dust cover of the present invention.

FIG. 11 shows a schematic diagram of the structure of the light-emitting assembly and the active wheel housing of the present invention.

FIG. 12 shows a schematic diagram of the structure of the first dust cover and the fixing seat of the present invention.

Reference to the following list of elements used in the drawings may facilitate review of the drawings.
1 Active Wheel Housing
2 Driven Wheel Housing
3 Holding Accommodation Space
4 Exhaust Hole Air Vent
5 Air Inlet Holes
6 Driving Motor
7 Wheel Hub Shaft Axle
8 Fixed Seat
9 Gear Accommodation Cavity
10 Dust-Proof Space
11 Toothed Gear Ring
12 Third Transmission Drive Gear
13 Gear Shaft
14 First Transmission Drive Gear
15 Second Transmission Drive Gear
17 First Dust Cover
18 Second Dust Cover
19 Light Emitting Member
20 Circuit Board
21 Accommodating Containment Cavity
22 Tire
23 Toroidal Magnetic Core
24 Electric Wires
25 Seals
181 Accommodating Slot
401 Air Guide Block
801 Axle Sleeve Bushing
802 Motor Mounting Cavity
803 Axle Shaft Hole
804 Ventilation Hole

### DETAILED DESCRIPTION OF THE EMBODIMENTS

To facilitate the understanding of those skilled in the art, the present invention is further described below in conjunction with embodiments and the accompanying drawings, and references to embodiments are not intended to be a limitation of the present invention.

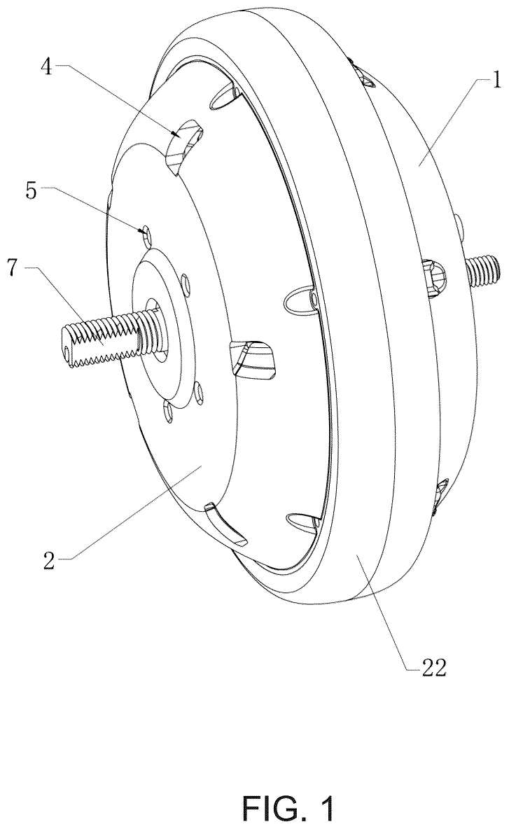

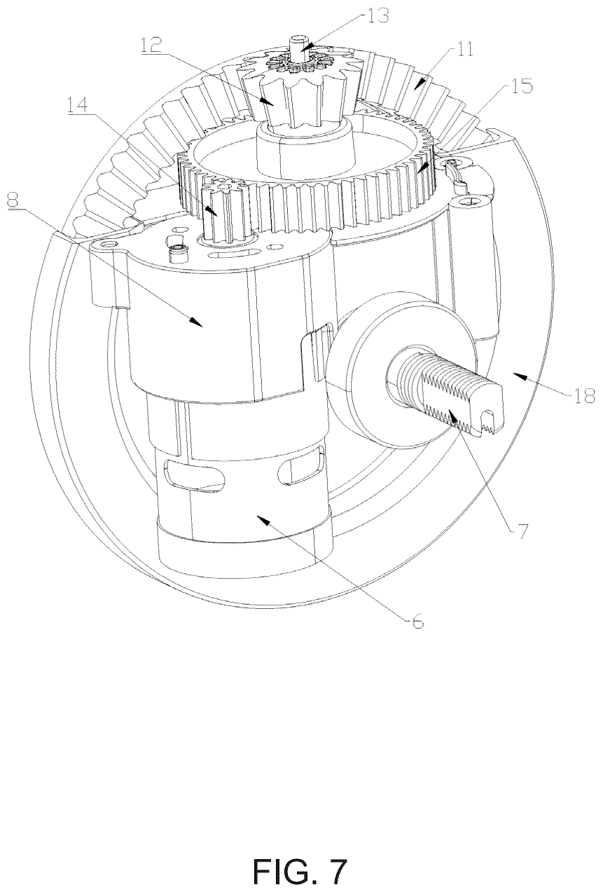

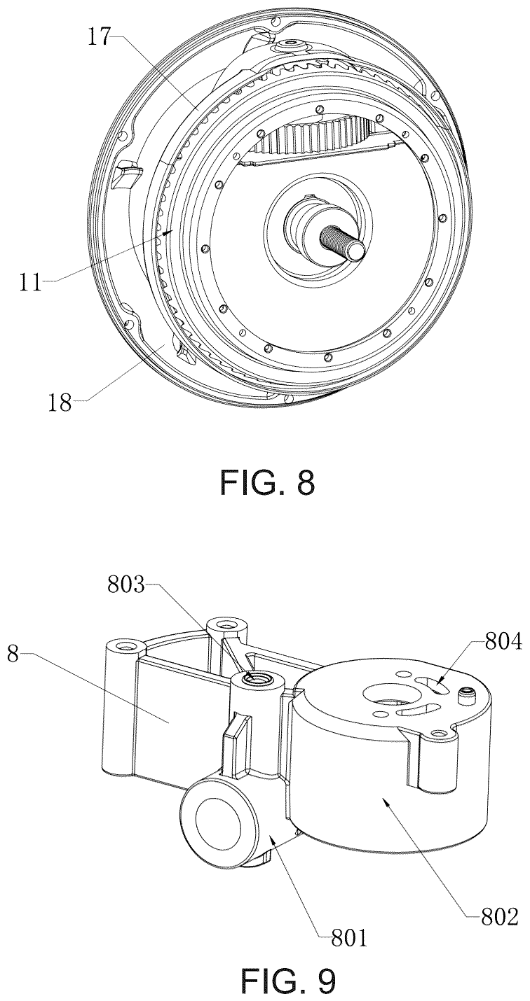

As shown in FIGS. 1 to 11, the present invention provides a motorized wheel hub including an active wheel housing 1, a driven wheel housing 2 connected to the active wheel housing 1, a wheel hub shaft axle 7 running through the active wheel housing 1 and the driven wheel housing 2, a holding accommodation space 3 enclosed by the inner walls of the active wheel housing 1 and the driven wheel housing 2, a drive assembly disposed within the holding accommodation space 3, and a heat dissipation mechanism for dissipating heat from the holding accommodation space 3. The drive assembly has a driving motor 6 mounted on one side of the wheel hub shaft axle 7 and a transmission assembly disposed in the holding accommodation space 3. The driving motor 6 drives the active wheel housing 1 to rotate around the wheel hub shaft axle 7 by means of the transmission assembly. The active wheel housing 1 and driven wheel housing 2 are combined to form a hub rotating around the wheel hub shaft 7. The active wheel housing 1 and driven wheel housing 2 are provided with tires 22 on the outer circumference.

In the present technical solution, the wheel hub shaft axle 7 runs through both sides of the active wheel housing 1 and the driven wheel housing 2. The driving motor 6 is provided on one side of the wheel hub shaft 7. The output shaft of the driving motor 6 then drives the active wheel housing 1 and the driven wheel housing 2 to rotate around the wheel hub shaft 7 through the transmission assembly, thereby in order to realize the function of the motorized wheel. Preferably, the wheel hub shaft 7 is coaxially mounted with the active wheel housing 1 and the driven wheel housing 2. The design of the present structure differs from conventional motorized wheel hub structures in that its wheel hub shaft is capable of running through both sides of the wheel hub, and the wheel hub shaft 7 is used as a fixed shaft connected to the outside and is not a drive shaft. In practical application, only the two ends of the wheel hub shaft 7 are fixedly connected with the external parts, and the movement of the external parts can be realized by driving the rotation of the active wheel housing 1 and the driven wheel housing 2 under the coordinated action of the driving motor 6 and the transmission assembly. The design of this structure can, on the one hand, solves the defect that the existing wheel motor can only be connected to the outside on one side. On the other hand, the through design of the wheel hub shaft axle 7 can effectively make the assembly of the wheel hub and the external parts more stable and reliable and also ensure the coaxially between the wheel hub and the wheel hub shaft axle 7, so as to improve the balance and stability of rotation of the wheel hub.

Meanwhile, in this technical solution, the electric wheel hub is also provided with a heat dissipation mechanism. Since the driving motor 6 is built into the wheel hub, the driving motor 6 will generate heat when working, and when the heat inside the wheel hub is too high, the heat will cause the driving motor 6 to burn out or even cause the wheel hub to spontaneously combust. As a result, the heat dissipation mechanism of the electric wheel hub discharges the heat inside the wheel hub, so that the temperature inside the wheel hub will not be too high, thereby improving the stability of the use of the electric wheel hub.

In this embodiment, as shown in FIGS. 1 to 3, the heat dissipation structure includes an exhaust hole air vent 4 and air inlet holes 5 provided on the active wheel housing 1 and/or the driven wheel housing 2. The exhaust hole air vent 4 and air inlet holes 5 are both connected to the holding accommodation space 3. The holding accommodation space 3 collects a large amount of heat when the driving motor 6 is in operation. When the active wheel housing 1 and the driven wheel housing 2 are in operation, the exhaust hole air vent 4 and the air inlet holes 5 communicate with the outside so that the holding accommodating space 3 can realize continuous air intake and outlet with the outside, thereby forming a circulating airflow to transfer the heat inside the holding accommodating space 3 out of the hub, thereby allowing the hub to realize the role of heat dissipation, and avoiding the problem of excessive heat inside the hub leading to the motor being burned out or spontaneous combustion of the hub.

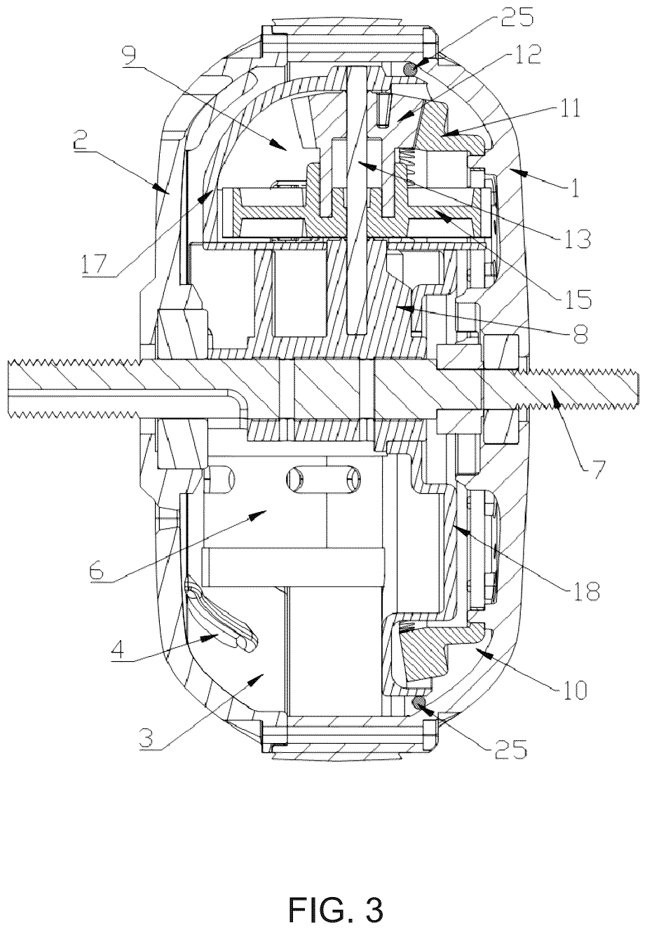

In this embodiment, as shown in FIGS. 3 to 5, the exhaust hole air vent 4 and air inlet holes 5 are provided on the side wall of the driven wheel housing 2, and the exhaust hole air vent 4 is provided with an air guide block 401 on one side of the exhaust hole air vent 4, one side of the air guide block 401 is connected to the side wall of the air vent 4, and the other side of the air guide block 401 extends to an inclined position in the storage space 3. The wind guide block 401 is designed so that, on the one hand, the driven wheel housing 2 When rotating, the wind guide block 401 forms a wind scraper in the holding accommodation space 3 to hang out the hot air in the holding accommodation space 3 to the outside of the wheel hub through the exhaust hole air vent 4; on the other hand, it also increases the exhaust volume of the exhaust hole air vent 4 as well as the exhaust speed, so as to improve the efficiency of heat dissipation. The structure design is simple and compact, and the heat dissipation effect is good. In practice, when the driven wheel housing 2 is rotating, the airflow outside the driven wheel housing 2 will flow out quickly along the air guide block 401 of the exhaust hole air vent 4 to the outside of the holding accommodating space 3, so that the heat in the holding accommodation space 3 is synchronized with the heat, resulting in the air pressure inside the holding accommodation space 3 being lower than the external atmospheric pressure, and under the action of the atmospheric pressure, the space will also flow quickly from the air inlet holes 5 to the holding accommodation space 3, thus allowing the wheel hub to form an airflow in and out of the hub.

Since the driving motor 6 itself has a mechanism for exhausting air to dissipate heat, the hot air flow discharged by the drive motor 6 into the holding accommodation space 3 causes the air in the holding accommodation space 3 to cause a turbulent air flow, and the exhaust hole air vent 4 and intake holes 5 of the present follower driven wheel housing 2 are designed so as to form a circulating outwardly-flowing air flow in the holding accommodation space 3 so that the heat in the holding accommodation space 3 is continually discharged outwardly, and the heat is thereby dissipated efficiently.

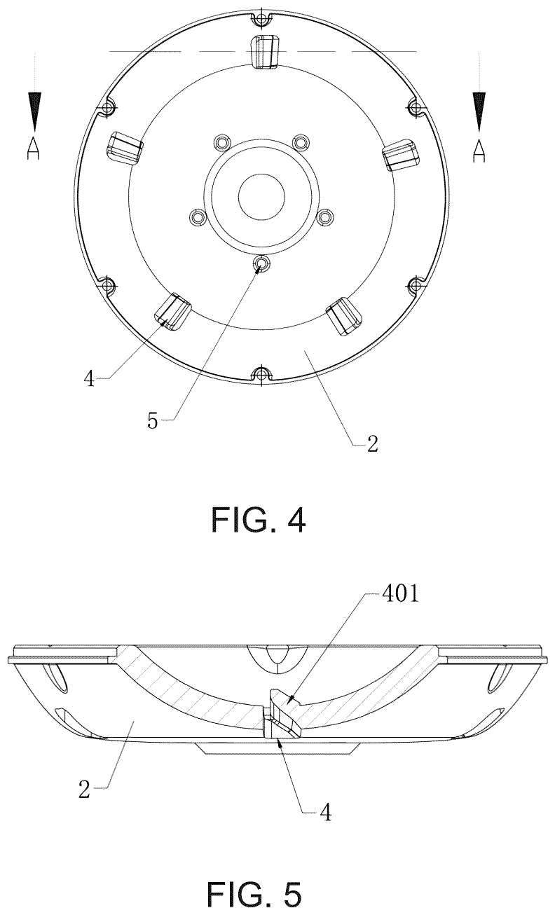

Preferably, as shown in FIGS. 1 and 4, the distance between the center of the air exhaust hole air vent 4 and the center of the wheel hub shaft axle 7 is greater than the distance between the center of the air intake holes 5 and the center of the wheel hub shaft axle 7. The air intake holes 5 and the number of the air intake holes 5 are plurality, the plurality of the exhaust hole air vent 4 are provided in a circumferential array around the center of the driven wheel housing 2, and the plurality of the exhaust hole air vent 4 are provided in a circumferential array around the center of the driven wheel housing 2. The further away from the center of the wheel hub shaft axle 7, the faster the linear speed of the wheel hub is when it is rotating, and thus by setting the exhaust hole air vent 4 farther away from the center of the wheel hub shaft axle 7, the air inside the holding accommodation space 3 can be discharged quickly, so that a pressure difference is formed between the holding accommodation space 3 and the atmospheric pressure, which facilitates the entry of external gases into the holding accommodation space 3 through the air inlet holes 5, and a circulating airflow is formed inside the holding accommodation space 3. The circulating airflow continuously brings in the low temperature gas and takes away the high temperature gas to realize the function of heat dissipation.

In practice, since the upper end portion and the lower end portion of the driving motor 6 are provided with air inlet ports, and the upper end portion of the driving motor 6 is provided with an exhaust port between the upper end portion and the lower end portion of the driving motor 6, and an exhaust fan is provided in the exhaust port for dissipating the heat of the driving motor 6, the hot air discharged from the driving motor 6 will cause a turbulent airflow to form in the holding accommodating space 3. As a result, the present heat dissipation structure can form a stabilized circulating airflow from the turbulent airflow in the holding accommodation space 3, carry heat out of the hub, and avoid excessive heat in the holding accommodation space 3.

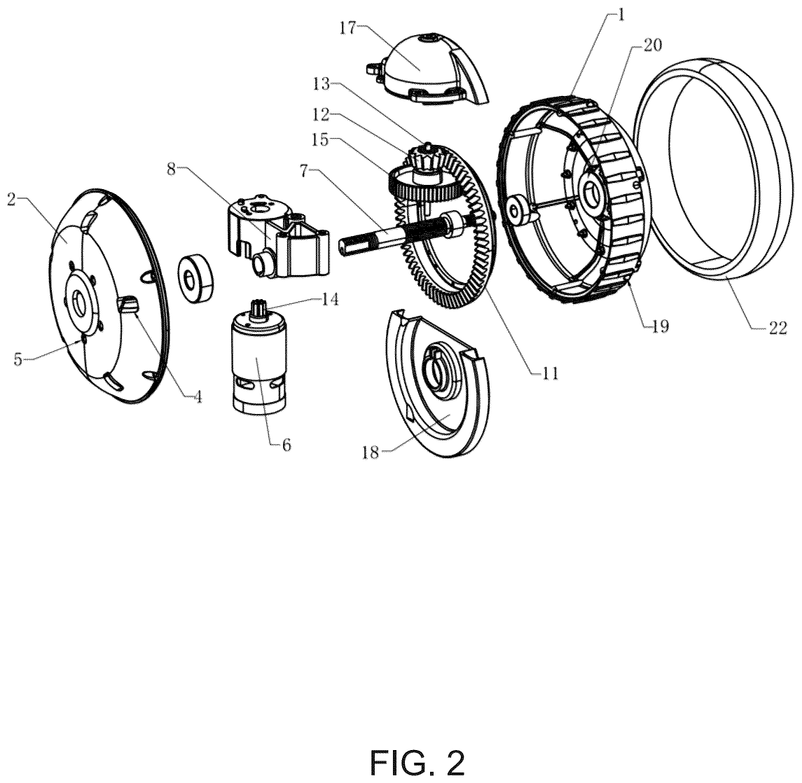

In the present technical solution, as shown in FIGS. 2 and 3, the transmission assembly comprises a toothed gear ring 11 connected to the active wheel housing 1, a first transmission drive gear 14 disposed on the output shaft of the driving motor 6, a gear shaft 13 disposed in the holding accommodation space 3, a second transmission drive gear 15 rotationally disposed on the gear shaft 13, and a third transmission drive gear 12 rotationally disposed on the gear shaft 13, the second transmission drive gear 15 is connected to the third transmission drive gear 12, the first transmission gear 14 engages with the second transmission drive gear 15, and the third transmission drive gear 12 engages with the toothed gear ring 11. Preferably, the axis of the toothed gear ring 11 is parallel to the axis of the wheel hub shaft axle 7, and the axis of the gear shaft 13 is parallel to the axis of the output shaft of the driving motor 6. The first transmission drive gear 14 and the second transmission drive gear 15 are driven by an external gear, and the third transmission drive gear 12 and toothed gear ring 11 are driven by a bevel gear. In practical application, the driving motor 6 drives the first transmission drive gear 14 to rotate, the rotating first transmission drive gear 14 drives the second transmission drive gear 15 to rotate, the rotating second transmission drive gear 15 drives the third transmission drive gear 12 to rotate, the rotating gear shaft 13 drives the third transmission drive gear 12 to rotate, the rotating third transmission drive gear 12 drives the toothed gear ring 11 to drive the rotation of the active wheel housing 1. The design of this structure is simple and compact, and the operation is stable and reliable.

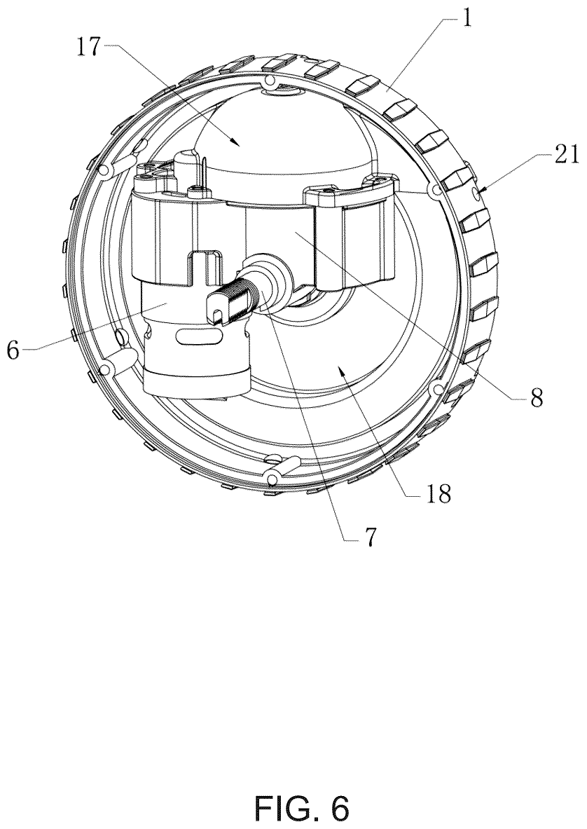

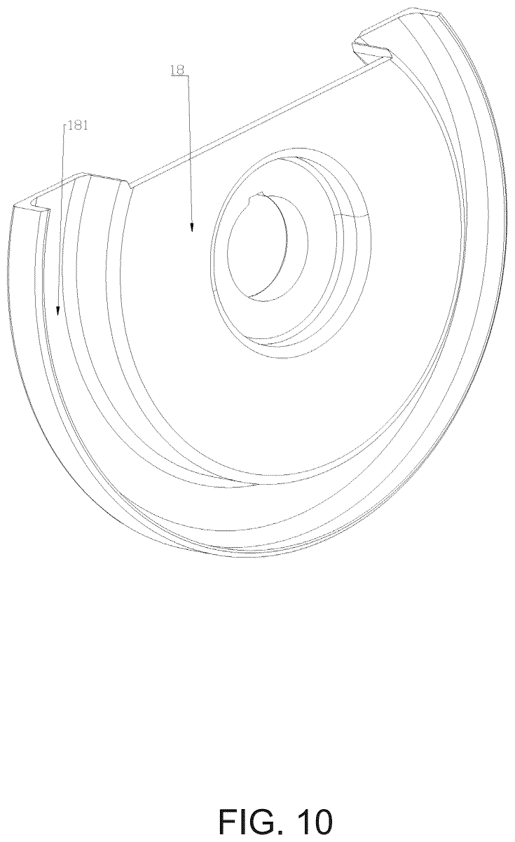

In the present technical solution, as shown in FIGS. 2 and 6, the electric hub further comprises a dustproof mechanism for dustproofing the transmission assembly; the dustproof mechanism comprises a first dust cover 17 and a second dust cover 18 provided in the holding accommodation space 3, and the first dust cover 17 is used to cover the output shaft of the driving motor 6, the first transmission drive gear 14, the second transmission drive gear 15, the third transmission drive gear 12 and the upper part of the toothed gear ring 11, and the second dust cover 18 is used to cover the lower part of the toothed gear ring 11. The first dust cover 17 and second dust cover 18 can block the external dust brought by the air flow in the holding accommodation space 3 and the dust discharged from the carbon brushes inside the driving motor 6, to effectively protect the efficient operation of the transmission assembly and improve the operational stability of the hub. Preferably, as shown in FIG. 10, the second dust cover 18 is provided with an accommodating slot 181 for the toothed gear ring 11. When the second dust cover 18 is mounted with the active wheel housing 1, this accommodating slot 181 can fully enclose the lower portion of the toothed gear ring 11 for dust protection, ensuring that dust does not easily enter the toothed gear ring 11.

In the technical solution, as shown in FIG. 2, FIG. 6 and FIG. 9, the motorized hub further comprises a fixed seat 8 disposed in the holding accommodation space 3 connected to the wheel hub shaft axle 7, the first dust cover 17 and second dust cover 18 are respectively disposed on the fixed seat 8; the fixed seat 8 is provided with an axle sleeve bushing 801 for cooperating with the wheel hub shaft axle 7; the fixed seat 8 is provided with an axle shaft hole 803 for motor mounting cavity 802 for driving motor 6 and axle shaft hole 803 for gear shaft 13; the motor mounting cavity 802 is provided with ventilation hole 804 at the top of the motor mounting cavity 802. The fixed seat 8 is fixedly mounted on the wheel hub shaft axle 7 through the axle sleeve bushing 801, which fixes the driving motor 6 through the motor mounting cavity 802 and the gear shaft 13 through the axle shaft hole 803. The driving motor 6 and the transmission assembly are thereby stably secured in the holding accommodation space 3 by the motor mounting cavity 802 and the gear shaft 13 by the axle shaft hole 803. A ventilation hole 804 at the top of the motor mounting cavity 802 is used to enable air intake at the upper end of the driving motor 6.

In this technical solution, the first dust cover 17 is connected to the top of the fixed seat 8, and the first dust cover 17 is provided with a gear accommodating cavity 9 for accommodating the first transmission drive gear 14, second transmission drive gear 15, third transmission drive gear 12, and gear shaft 13; and the second dust cover 18 is connected to the fixed seat 8 is located below the first dust cover 17. Specifically, the output shaft of the driving motor 6 is located in the gear housing cavity and connected to the first transmission drive gear 14. The inner wall of the main wheel housing 1 encloses the gear accommodation cavity 9 to form a gear box, allowing the first dust cover 17 to also function as a gear box.

In the present technical solution, as shown in FIG. 3, the first dust cover 17, the second dust cover 18 and the inner wall of the active wheel housing 1 are arranged to enclose a dust-proof space 10, the driving motor 6 is located outside the dust-proof space 10, and the output shaft of the driving motor 6, the first transmission drive gear 14, the second transmission drive gear 15, the third transmission drive gear 12, and the upper portion of the toothed gear ring 11 are located inside the dust-proof space 10. Specifically, the first dust cover 17 and the second dust cover 18 are combined to form a dust cover, as shown.

In FIG. 3, with the active wheel housing 1, the toothed gear ring 11, the dust cover, and the driving motor 6 being disposed sequentially along the wheel hub shaft axle 7 in a right-to-left direction. The dust cover is connected to the fixing seat, and the toothed gear ring 11 is mounted on the inner side wall of the active wheel housing 1. The driving motor 6 is mounted on the fixed seat 8 by means of which the body of the driving motor 6 is located outside the dust cover, and the output shaft of the driving motor 6 and the first transmission drive gear 14 project into the dust cover. The design of the first dust cover 17 and the second dust cover 18 can effectively block turbulent gases and pollutants discharged from the body of the drive motor 1 from entering the dustproof space 10, prevent the transmission components from being contaminated by pollutants in the outside world and affecting the precision and efficiency of the transmission, so as to reduce the wear and tear of the transmission components, and to improve the quality of use of the present motorized wheel hub.

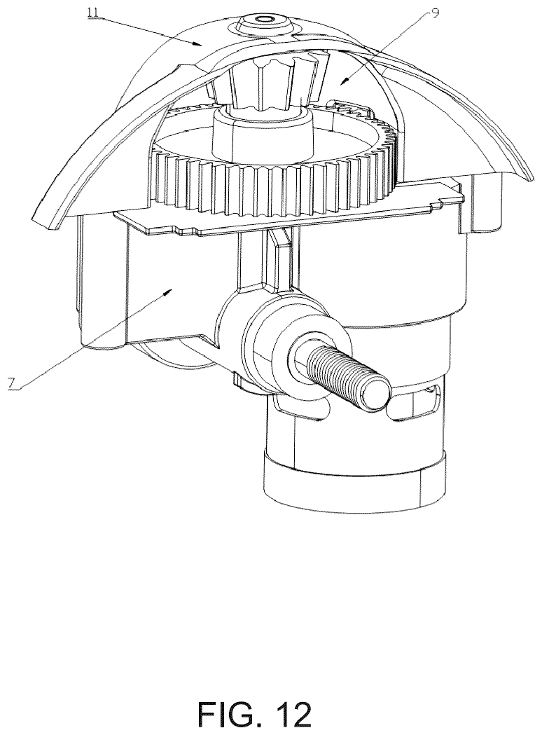

In this technical solution, as shown in FIG. 12, seals 25 are provided between the side edges of the first dust cover 17 and the side edges of the second dust cover 18 and the inner wall of the active wheel housing 1. Specifically, due to the assembly, there will be a small gap between the side edges of the protective cover and the inner wall of the active wheel housing 1, but the gap is so small that essentially contaminants will not pass through the gap into the dust-proof space 10. If necessary, it is also possible to provide a seal 25 in the gap between the first dust cover 17, the second dust cover 18 and the inner wall of the active wheel housing 1. The seal 25 can be made of sealing paste, dust brushes, sealing gaskets and liquid sealant. The structure can be designed to further provide sealing of the dust-proof space 10.

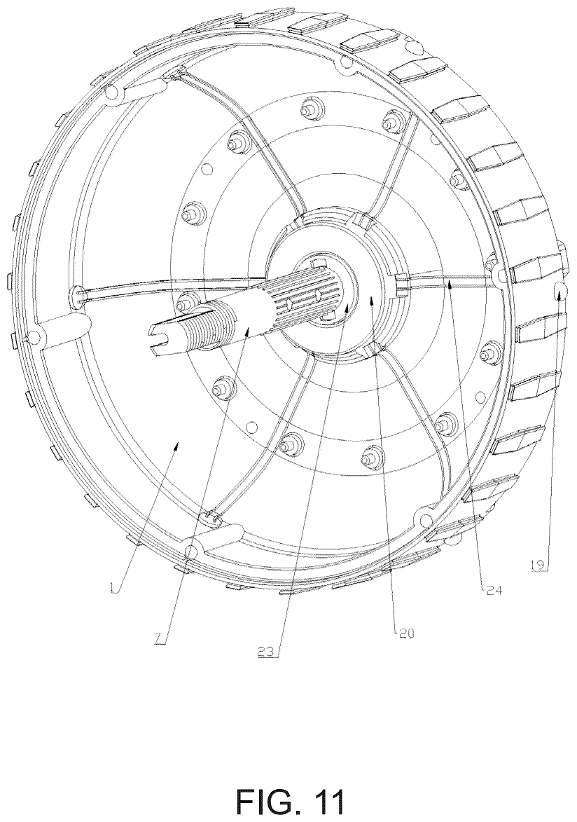

In the present technical solution, as shown in FIG. 11, the electric wheel hub further comprises a light-emitting assembly, the light-emitting assembly comprising a light-emitting member 19, a circuit board 20, a coil (not shown in the figure), and a circular shaped toroidal magnetic core 23, the circuit board 20 and the coil being annular in shape; the toroidal magnetic core 23 being fixedly mounted to the wheel hub shaft axle 7, the circuit board 20 and the coil being disposed in the active wheel housing 1, the toroidal magnetic core 23 is disposed on the inside of the circuit board 20, the coil is disposed on the inside of the circuit board 20 between the circuit board 20 and the toroidal magnetic core 23; the light emitting member 19 is disposed on the active wheel housing 1 electrically connected to the circuit board 20. In practical application, the rotating active wheel housing 1 drives the circuit board 20 to rotate, the rotating circuit board 20 drives the coil to rotate around the toroidal magnetic core 23, and the toroidal magnetic core 23 makes a movement to cut the magnetic inductance, which energizes the circuit board 20, and in turn energizes the light emitting member 19 to emit light, which makes the wheel hub The outer rounded edges are capable of emitting dazzling light effects.

Specifically, the number of the light emitting members 19 is a plurality, and the plurality of the light emitting members 19 are each connected to the circuit board 20 via electric wires 24; the electric wires 24 are affixed to the inner wall of the active wheel housing 1 to prevent the electric wires 24 from interfering with the toothed gear ring 11. The active wheel housing 1 is provided with an accommodating containment cavity 21 on the outer circular edge, the accommodating containment cavity 21 are in a plurality, and the plurality of accommodating containment cavity 21 are provided in an array around the outer circular edge of the active wheel housing 1. The light emitting member 19 is mounted in the accommodating containment cavity 21.

All technical features in this embodiment are freely combinable as desired. The electric wheel is preferably standalone such as for a unicycle.

The above embodiment is a better realization of the present invention, in addition to which the present invention can be realized in other ways, and any obvious substitution without departing from the conception of the present technical solution is within the scope of protection of the present invention.

1. An electric wheel comprising:
a. an active wheel housing;
b. a driven wheel housing, wherein the driven wheel housing is connected to the active wheel housing;
c. a wheel hub shaft axle, wherein the wheel hub shaft axle runs through the active wheel housing and the driven wheel housing;
d. a holding accommodation space, wherein the holding accommodation space is enclosed by the inner walls of the active wheel housing and the driven wheel housing;
e. a driving assembly, wherein the a driving assembly is disposed within the holding accommodation space; and
f. a heat dissipation structure, wherein the heat dissipation structure dissipates heat from the holding accommodation space, wherein the drive assembly includes:
i. a driving motor provided on one side of a wheel hub shaft axle; and
ii. a transmission assembly provided in the holding accommodation space, wherein the driving motor drives the active wheel housing to rotate around the wheel hub shaft axle using the transmission assembly.

2. The electric wheel of claim 1, wherein the heat dissipation structure comprises an exhaust hole air vent and air inlet holes formed on the active wheel housing or the driven wheel housing, wherein the exhaust hole air vent and air inlet holes connect to the holding accommodation space.

3. The electric wheel of claim 2, characterized in that: the exhaust hole air vent and air inlet holes are provided on the side wall of the driven wheel housing, wherein the exhaust hole air vent is provided with an air guide block on one side of the exhaust hole air vent, one side of the air guide block is connected to the side wall of the exhaust hole air vent (4), and the other side of the air guide block extends into the holding accommodation space in an inclined setting.

4. The electric wheel of claim 3, wherein the distance between the center of the exhaust hole air vent and the center of the wheel hub shaft axle is greater than the distance between the center of the air inlet holes and the center of the wheel hub shaft axle.

5. The electric wheel of claim 4, wherein the transmission assembly comprises a toothed gear ring connected to the active wheel housing, a first transmission drive gear set on the output shaft of the driving motor, a gear shaft set in the holding accommodation space, a second transmission drive gear set on the gear shaft, and a third transmission drive gear set on the gear shaft, the first transmission drive gear meshing with the second transmission drive gear and the third transmission drive gear meshing with the toothed gear ring.

6. The electric wheel of claim 5, wherein the electric wheel hub further comprises a dustproof mechanism for dustproofing the transmission components; wherein the dustproof mechanism comprises a first dust cover and a second dust cover arranged in the holding accommodation space, and the first dust cover is used to cover the output shaft of the driving motor, the first transmission drive gear, the second transmission drive gear, the third transmission drive gear and the upper part of the toothed gear ring, and the second dust cover is used to cover the lower part of the toothed gear ring.

7. The electric wheel of claim 6, wherein: the first dust cover, the second dust cover and the active wheel housing are combined to form a dust-proof space, the driving motor is located outside of the dust-proof space, and the output end of the driving motor and the transmission assembly are located in the dust-proof space; a seal is arranged between the sides of the first dust cover and the inner wall of the active wheel housing, and the seal is arranged between the second dust cover the inner wall of the active wheel housing.

8. The electric wheel of claim 7, wherein the second dust cover is provided with an accommodation slot for the toothed gear ring.

9. The electric wheel of claim 5, wherein the electric wheel hub further comprises a fixed seat arranged in a holding accommodation space and connected to a wheel hub shaft axle, the fixed seat being provided with a axle sleeve bushing for cooperating with the wheel hub shaft axle, the fixed seat being provided with a motor mounting cavity for mounting and fixing a driving motor, the fixed seat is provided with a axle shaft hole for fixing the gear shaft; the top of the motor mounting cavity is provided with a ventilation hole; the first dust cover is connected to the top of the fixed seat, and the first dust cover is provided with a gear accommodation cavity for accommodating the first transmission drive gear, the second transmission drive gear, the third transmission drive gear and the gear shaft are accommodated in the gear accommodation cavity; the second dust cover is connected to the fixed seat and is located below the first dust cover.

10. The electric wheel of claim 4, wherein the electric wheel hub further comprises a light-emitting assembly, the light-emitting assembly comprising a light emitting member, a circuit board, a coil, and a toroidal magnetic core. The circuit board and the coil are in the form of a ring; the toroidal magnetic core is fixedly mounted on the wheel hub shaft axle, the circuit board and the coil are provided on the active wheel housing, the toroidal magnetic core is placed on the inner side of the circuit board; and the coil is disposed on the inner side of the circuit board and between the circuit board and wheel hub shaft axle; the light emitting member is provided on the active wheel housing is electrically connected to the circuit board.
